(19) United States
(12) Patent Application Publication
(10) Pub. No.: US 2003/0224962 A1
(43) Pub. Date: Dec. 4, 2003

(54) Wet dryer sheets and sheet dispenser

(76) Inventor: Mary A. Fryc, Tampa, FL (US)

Correspondence Address: Richard C. Litman, LITMN LAW OFFICES, LTD., P.O. Box 15035, Arlington, VA, 22215, US

(21) Appl. No.: 10/304,022

(22) Filed: Nov. 26, 2002

Related U.S. Application Data
(60) Provisional application No. 60/384,821, filed on Jun. 4, 2002.

(51) Int. Cl. C11D 17/00; C11D 3/00

(52) U.S. Cl. 510/438; 510/515; 510/519

(57) ABSTRACT

A dispenser containing wet (moist) dryer sheets for use in removing wrinkles from dry clothes in a rotating hot-air dryer. The sheets are stacked together inside a flexible box-shaped plastic bag that fits inside a comparable box-shaped non-flexible dispenser container. The sheets can also be folded prior to being stacked together. Also, besides moisture, the sheets can include a fabric softener as well as perfume. The invention includes a method of using the wet dryer sheets to remove wrinkles from dry clothes.

### CROSS-REFERENCE TO RELATED APPLICATION

This application claims the benefit of U.S. Provisional Patent Application Serial No. 60/384,821, filed Jun. 4, 2002.

### FIELD OF THE INVENTION

The present invention relates to wet or moist sheets used in a dryer for removing wrinkles in dry clothing. The sheets are individually dispensed from a plastic box which itself contains a box-shaped plastic bag enclosing a plurality of stacked moist sheets and which is adequately sealed against loss of moisture. Besides moisture, the sheets can also include fabric softener and perfume or scent. The invention includes a method of using the sheets for removing wrinkles from dry clothing.

### DESCRIPTION OF RELATED ART

Moist sheets and dry sheets are well known for use in general cleaning of surfaces, picking up dust, etc. They are typically supplied in flexible plastic containers. Many of the dry sheets are commonly made up of microfibers and complex fibers (e.g., fibers made up of combinations of two or more fibers that have different thicknesses and/or different cross-sections).

Also, dry sheets containing fabric softener are known that are used in clothes dryers for preventing cling and wrinkles. Using the conventional dry softener sheets, the clothes are normally initially wet they are placed in the dryer along with the dry softener sheet. The combination of moisture and the fabric softener in the dry sheet helps to simultaneously remove wrinkles from the wet clothes and prevent static cling.

However, frequently it is desired to remove wrinkles from dry clothing rather than wet. Therefore, there is a need for wet dryer sheets that can be used in a shortened hot-air dryer cycle for removing wrinkles from dry clothes. Moreover, there is a need for a convenient method of using wet dryer sheets to remove wrinkles from dry clothing in a hot-air clothes dryer.

U.S. Pat. No. 5,547,476, issued to Siklosi et al. on Aug. 20, 1996, and U.S. Pat. No. 5,630,848, issued to Young et al. on May 20, 1997, both teach a carrier sheet used for dry cleaning clothes in a conventional home hot-air clothes dryer. The Siklosi and Young patents teach that moisture provided in the carrier sheets in addition to the cleaning composition help to remove wrinkles. The Siklosi and Young patents lack any teaching regarding the type of sheets, a sheet dispenser for one-at-a-time dispensing while slowing or preventing moisture loss during use and storage, and the manner of replenishing the sheets in a convenient sealed box-like bag for use in the dispenser.

U.S. Pat. No. 5,658,651, issued to Smith et al. on Aug. 19, 1997, teaches fabric treatment compositions for use with a vented bag in a home hot air dryer.

A moist sheet product called Dryel® made by Proctor & Gamble is generally available for use in removing wrinkles and cleaning clothes in a hot air dryer. The method requires the use of a bag to hold the clothes and the dryer sheet during the de-wrinkling and cleaning cycle in the dryer. Also, the sheets are individually wrapped rather than provided as stacked, folded sheets in a sealed box-like bag. The method of using these sheets differs significantly from the present invention because it requires a separate bag to contain the sheet product and the clothes, that is not required by the present inventive method.

None of the above inventions and patents, taken either singly or in combination, is seen to describe the instant invention as claimed.

### SUMMARY OF THE INVENTION

The wet dryer sheets of the present invention are used in a conventional hot-air clothes dryer to remove wrinkles from dry clothing in a shortened dryer cycle compared with a standard drying cycle for wet clothes. The sheets are dispensed from a box-like container made of non-flexible plastic. Inside the box-like container, wet sheets are stacked in a layered arrangement inside a box-shaped replacement bag for dispensing the sheets one-at-a-time through an access opening in the container. The bag prevents or reduces the loss of moisture from the sheets when they are not being dispensed. Replacement bags are initially sealed with a sticker which must be removed before dispensing the sheets. When the dispenser container becomes empty, the empty bag is removed and a new replacement bag containing a fresh set of unused wet sheets is placed into the dispenser container.

The wet sheets contain sufficient moisture to remove wrinkles from dry clothes during a shortened dryer cycle (e.g., 10-30 minutes). In addition, the sheets may contain fabric softener (to prevent static cling) as well as perfume or scent.

Furthermore, the method of using the inventive wet sheets includes placing a wet sheet with the dry clothes in a hot-air clothes dryer, operating the dryer for a sufficient period of time to remove the wrinkles and then stopping the dryer and removing the de-wrinkled clothes.

Accordingly, it is a principal object of the invention to provide a non-flexible dispenser containing wet dryer sheets for removing wrinkles from dry clothes, the sheets being contained within a box-shaped flexible plastic bag inside the dispenser.

It is another object of the invention to provide a wet sheet dispenser which can be easily replenished with a replacement box-shaped plastic bag containing unused wet sheets which is additionally sealed with an adhesive sticker.

It is a further object of the invention to provide a dispenser containing wet sheets as described above in which the sheets additionally are moistened with a liquid or wet fabric softener to prevent static cling.

Still another object of the invention is to provide a dispenser containing wet sheets as described above in which the sheets additionally are moistened with a perfumed or scented fabric softener.

Still another object of the invention is to provide a method of using a wet sheet including placing a wet sheet with dry wrinkled clothing in a hot-air clothes dryer, operating the clothes dryer for a period of time sufficient for the wet sheets to remove the wrinkles from the clothing, and then removing the de-wrinkled clothing from the dryer.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a wet dryer sheet dispenser for dispensing wet dryer sheets for use in a hot-air dryer according to the present invention.

FIG. 2 is a plan view of the box-shaped replacement bag containing unused wet sheets ready for use in the dispenser.

Similar reference characters denote corresponding features consistently throughout the attached drawings.

### DETAILED DESCRIPTION OF THE PREFERRED EMBODIMENTS

The present invention is directed to a wet dryer sheets, to a dispenser containing the wet dryer sheets which are used to condition and remove wrinkles from dry clothes in a hot-air dryer, and to a method of using the wet sheets.

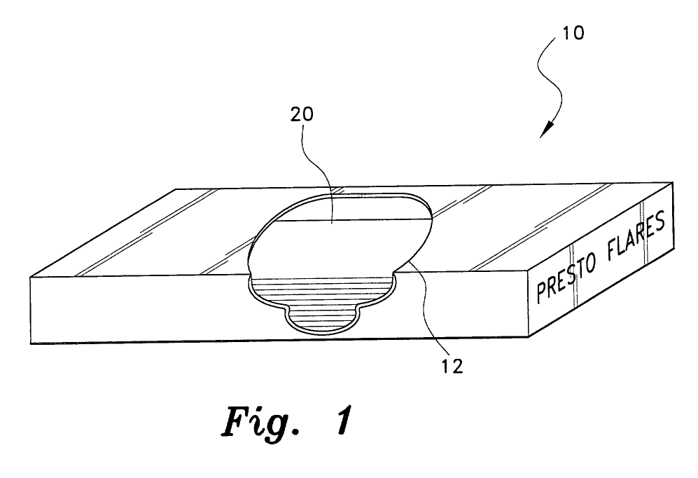

FIG. 1 shows a wet sheet dispenser 10 according to the invention. A stack of wet (moist) sheets 20 is shown through the opening 12 of the dispenser 10. The sheets 20 are stacked and can also be folded prior to being stacked.

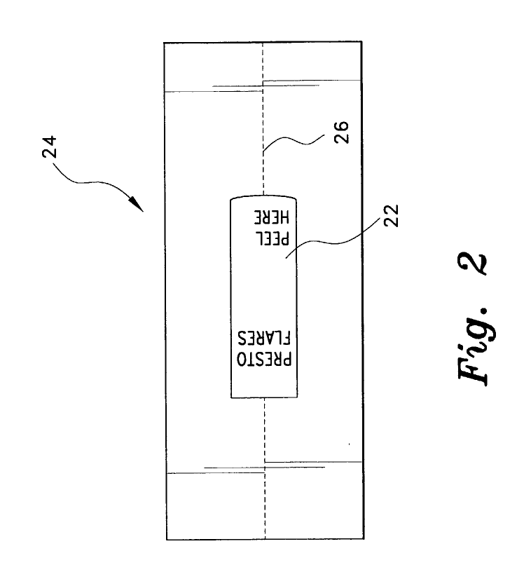

FIG. 2 shows a replacement supply of wet sheets stacked within a sealed bag 24, preferably transparent, having a box-like shape that is comparable in size to the inside of the dispenser container 10. When needed, the adhesive seal strip 22 is removed to expose a lengthwise perforation 26 through which the sheets are removed while maintaining sufficient sealing against moisture loss.

The individual sheets can be made of water impregnated natural fabric (e.g, linen or cloth) or woven or nonwoven plastic fibers or microfibers. Alternatively, the sheets can be moistened by a liquid or wet fabric softener, or a solid fabric softener dissolved in water, so that the moisture and fabric softener conditions dry clothing for comfort, removes wrinkles from dry clothing, and adds resistance to static cling. Furthermore, the sheets can be moistened with a wet fabric softener which includes any known water-compatible perfume or scent to provide an aroma of freshness. The sheets may be made from or treated with a flame retardant material for safe use in a dryer, as is known in the art.

The method of using the wet sheets includes: placing a wet sheet in a hot-air dryer along with dry clothes that are wrinkled, operating the dryer for a period of time sufficient to de-wrinkle the clothes, and removing the de-wrinkled clothes from the dryer. The amount of dry wrinkled clothes to place initially in the dryer as well as the length of time that is sufficient to dewrinkle the clothes will depend upon known variables including the type of clothes (e.g., cotton or synthetic fabric), their size, the extent of wrinkles in the clothing, and the type of dryer. These variables are well known to users of hot-air dryers and can easily be determined by routine experimentation in combination with loading guidelines given in the operating instructions provided by the dryer manufacturer.

It is to be understood that the present invention is not limited to the sole embodiments described above, but encompasses any and all embodiments within the scope of the following claims.

I claim:

1. A dispenser containing moist sheets for use in removing wrinkles from dry clothes in a rotating hot-air dryer, comprising:
a non-flexible dispenser container having an access opening defined therein; and
a flexible, box-shaped bag adapted for containing a plurality of stacked moisture-impregnated sheets in which the sheets are dispensable individually, said bag being disposed within said dispenser.

2. The dispenser according to claim 1, wherein the box-shaped bag has a perforation defining said access opening and further comprises a removable adhesive seal disposed over said perforation, in which the seal is removed prior to accessing the sheets and wherein the perforation reduces or prevents loss of moisture while permitting the sheets to be individually dispensed through the access opening.

3. The dispenser according to claim 1, further comprising a plurality of dryer sheets, said dryer sheets being moistened by a liquid and packaged within said bag.

4. The dispenser according to claim 3, wherein said liquid is water.

5. The dispenser according to claim 3, wherein said liquid is a wet fabric softener.

6. The dispenser according to claim 3, wherein said liquid is water having a water soluble fabric softener dissolved therein.

7. The dispenser according to claim 3, wherein said liquid is a scented liquid fabric softener.

8. A wet dryer sheet for conditioning and removing wrinkles from dry clothes, comprising a dryer sheet impregnated with a substance providing moisture.

9. The wet dryer sheet according to claim 8, wherein said substance is water.

10. The wet dryer sheet according to claim 8, wherein said substance is a liquid fabric softener.

11. A method of using the wet dryer sheet of claim 8, comprising the steps of:
providing a hot-air dryer and a quantity of wrinkled clothes;
placing the quantity of wrinkled clothes inside the hot-air dryer;
placing one said wet dryer sheet inside the hot-air dryer;
operating the hot-air dryer for a sufficient period of time to de-wrinkle the clothes;
removing the de-wrinkled clothes from the hot-air dryer; and
removing and discarding said wet dryer sheet from the dryer.

12. A wet dryer sheet in combination with a sheet dispenser, comprising:
a fabric sheet impregnated with a substance providing moisture;
a non-flexible dispenser container having an access opening defined therein; and
a flexible, box-shaped bag adapted for containing a plurality of said fabric sheets, said bag being disposed within said dispenser, said fabric sheet being packaged in said bag.
